(19) United States
(12) Patent Application Publication
(10) Pub. No.: US 2019/0244483 A1
(43) Pub. Date: Aug. 8, 2019

(54) SYSTEM, APPLICATION, AND METHOD OF WAGERING ON ONLINE GAMES OF SKILL AS A THIRD PARTY SPECTATOR

(71) Applicant: Mark Rey Collins, Upper Marlboro, MD (US)

(72) Inventor: Mark Rey Collins, Upper Marlboro, MD (US)

(21) Appl. No.: 15/892,339

(22) Filed: Feb. 8, 2018

(51) Int. Cl. G07F 17/32; A63F 13/86

(52) U.S. Cl. CPC G07F 17/3288; A63F 13/86; G07F 17/323

(57) ABSTRACT

An online game wagering system, including a plurality of gaming systems to allow a plurality of users to play an online video game thereon, a game server to provide, to the plurality of gaming systems, data required to access, operate and play the online video game on the plurality of gaming systems, a plurality of online computing devices to allow a plurality of third party spectators to view the online video game as it is played by the plurality of players in real time, and a transactional server to communicate with the plurality of online computing devices to allow the plurality of third party spectators to place wagers on at least one of the plurality of users playing the online video game.

### BACKGROUND

### 1. Field

The present general inventive concept relates generally to a system and method of allowing third parties to wager on online multiplayer video games.

### 2. Description of the Related Art

Online multiplayer video games may be played on various video game consoles, such as PLAYSTATION, NINTENDO WII, and XBOX, and are divided into two categories, namely (1) games of chance, and (2) games of skill. A game of skill is a game where an outcome is determined by mental and/or physical prowess, rather than by luck. A CALL OF DUTY Tournament, for example, requires a player to use hand-eye coordination, quick reactions, spatial relations skills, predictive thinking, and fast muscle response to be victorious. As another example, a game like CHESS contains no chance and requires a player's superior intellect and skill to determine the outcome. In contrast, a game of chance is generally considered to be a game in which chance is the sole or predominant determination of the outcome. For example, although BLACKJACK enthusiasts claim that card-counting is a skill that enhances a player's chance of winning, luck and chance are the predominant factors that determine winners and losers.

The distinction between games of skill and games of chance is an important one, because games of chance are considered gambling (which may be illegal in various jurisdictions), whereas games of skill are not considered gambling. United States Federal laws and most State laws follow the Standard Lottery Rule, which is a general rule governing sweepstakes and skill based games. The Standard Lottery Rule states that gambling involves any activity in which each of the following elements is present: (1) the award of a prize, (2) determined on the basis of chance, and (3) where consideration is paid. If, however, any of these three elements is missing, then the activity is not considered gambling. The prevailing rule in the United States is the element of chance is met if the activity requires some skill, but chance is predominate.

The Internet has become a place where video game enthusiasts can not only participate in playing online multiplayer video games, but also view others playing online multiplayer video games in real time. In recent times, video game enthusiasts have taken a particular interest in viewing other players playing online multiplayer video games are based on a skill of a player rather than on chance, which makes viewing these games exciting and unpredictable.

Although players involved in the actual game-play of these online multiplayer video games have the ability to place bets on who will win a particular online multiplayer video game and/or online video game tournament, third-party online spectators who are not involved in the actual game-play are not able to place side-bets or wagers on a particular online multiplayer video game and/or online video game tournament.

Therefore, there is a need for a system and method of allowing third-party online spectators of online multiplayer video games, who are not involved in the actual game-play, to place side-bets or wagers on a particular online multiplayer video game and/or online video game tournament.

### SUMMARY

The present general inventive concept provides a system, application, and method of allowing third-party non-player spectators to view and place bets on online multiplayer video games.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an online game wagering system, including a plurality of gaming systems to allow a plurality of users to play an online video game thereon, a game server to provide, to the plurality of gaming systems, data required to access, operate and play the online video game on the plurality of gaming systems, a plurality of online computing devices to allow a plurality of third party spectators to view the online video game as it is played by the plurality of players in real time, and a transactional server to communicate with the plurality of online computing devices to allow the plurality of third party spectators to place wagers on at least one of the plurality of users playing the online video game.

Each of the plurality of gaming systems may include a display unit to display images related to the online video game thereon, a game console to allow at least one of the plurality of users to play the online video game, a computing device to allow the at least one of the plurality of users to access at least one of a website, an application, the game server, and the transactional server, using credentials of the at least one of the plurality of users, and a video capturing device to capture live game-play images corresponding to the online video game from the game console that are also displayed on the display unit, and to transmit these captured live game-play images to the computing device in real time.

The captured live game-play images corresponding to the online video game may be streamed from the computing device in real-time to the at least one of the website, the application, the game server, and the transactional server, to be viewable by the plurality of third party spectators.

The captured live game-play images may be stored on the at least one of the website, the application, the game server, and the transactional server.

The computing device may allow each of the plurality of players to access the stored captured live game-play images and to transmit the stored captured live game-play images to at least one of a profile stored on the at least one of the website, the application, the game server, and the transactional server, a social media webpage corresponding to at least one of the plurality of players, and a video-streaming webpage.

The computing device may allow the at least one of the plurality of users to access the at least one of the website, the application, the game server, and the transactional server, to register a profile and to log into the at least one of the website, the application, the game server, and the transactional server, using the profile.

The at least one of the plurality of users may invite another one of the plurality of users via the computing device.

At least one of the website, the application, and the transactional servicer may send notifications to at least one of the plurality of users and the plurality of third party spectators regarding at least one of online video game times, online video game dates, and online video game tournament times, online video game tournament dates, information regarding at least one of the plurality of users, and information regarding the online video game.

The online video game may be a skill-based video game.

The plurality of gaming systems may be disposed in different locations around the world.

The transactional server may receive and authenticate credential information received from at least one of the plurality of players and the plurality of third party spectators.

The authentication by the transactional server may include age and location authentication of the at least one of the plurality of players and the plurality of third party spectators to ensure local law compliance.

The transactional server may receive electronic transfers of funds from the plurality of third party spectators via the plurality of online computing devices, and may secure the funds in an escrow account such that the funds and additional funds are retrievable by at least one of the plurality of third party spectators via at least one of the plurality of online computing devices after the online video game play has finished.

The transactional server may receive and store completed game statistics related to the online video game from at least one of the game server and the plurality of gaming systems.

The foregoing and/or other features and utilities of the present general inventive concept may also be achieved by providing a computing device running an application thereon, the computing device including a display unit to display the application including a live-streaming online video game played by a plurality of players, an input device to receive input within the application from a bettor regarding placing a wager on at least one of the plurality of players playing and winning the live-streaming online video game, a central processing unit (CPU) to process the input, a storage unit to store the input, a transmitter to transmit the input via the application to an external transactional server that also receives other input wagers from other bettors and stores the input and the other input wagers in an escrow account, and a receiver to receive an output via the application from the transactional server including the original input and at least a portion of the other input wagers in response to the at least one of the plurality of players winning the live-streaming online video game.

The live-streaming online video game may be a game of skill.

The foregoing and/or other features and utilities of the present general inventive concept may also be achieved by providing a method of wagering on online games of skill, the method including displaying, on a display unit of a computing device, the application including a live-streaming online video game played by a plurality of players, receiving input within the application, via an input unit of the computing device, from a bettor regarding placing a wager on at least one of the plurality of players playing and winning the live-streaming online video game, processing the input within a central processing unit of the computing device, storing the input in a storage unit of the computing device, transmitting the input via the application from the computing device to an external transactional server, receiving other input wagers from other bettors in the external transactional server, storing the input and the other input wagers in an escrow account associated with the external transactional server, and receiving, in the computing device, an output via the application from the transactional server including the original input and at least a portion of the other input wagers in response to the at least one of the plurality of players winning the live-streaming online video game.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a block diagram illustrating an online game wagering system, according to an exemplary embodiment of the present general inventive concept;

FIG. 2A is a block diagram illustrating a gaming system, according to an exemplary embodiment of the present general inventive concept;

FIG. 2B is a block diagram illustrating a game console, according to an exemplary embodiment of the present general inventive concept;

FIG. 3 is a block diagram illustrating a computing device, according to an exemplary embodiment of the present general inventive concept;

FIG. 4 is a block diagram illustrating another computing device, according to an exemplary embodiment of the present general inventive concept; and

FIG. 5 is a flow chart illustrating a method of wagering on online games of skill, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like or similar elements throughout the description of the figures.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

As applied herein, a “wager” or “wagering” may include players staking something of value (e.g., money) for an opportunity to win something of value (e.g., money, BITCOIN, etc.) subject to the outcome of an event (e.g., a video game contest between players), wherein an outcome of the event is predominantly determined by skill of the players involved in the event, and not a chance occurrence. In comparison, a “bet” or “gambling” involves taking something of value (e.g., money) for a chance to win something of value (e.g., a prize) subject predominantly to the outcome of an event (e.g., a lottery drawing), which is predominantly a chance occurrence.

A “multiplayer gaming network” or “gaming network” may include any networked medium that permits players to engage in a videogame or computer system game, or any other electronic gaming activity between/among the players. One example of a “multiplayer gaming network” suitable for use with various embodiments of the present general inventive concept, is an “XBOX LIVE” gaming network operatively associated with the “XBOX” gaming system (MICROSOFT CORPORATION).

A “video game” may include any electronically executed game that can be played over a multiplayer gaming network in accordance with one or more embodiments of the present general inventive concept. Examples of video games include, without limitation, Console-based games, such as those played on the “XBOX” gaming system, personal computer (“PC”) games, and a variety of other types of electronic games.

A “game console” may include any device or apparatus that can be configured for playing one or more video games on a multiplayer gaming network. Examples of “game consoles” may include, without limitation, video gaming system consoles, computer systems, personal data assistants (PDAs), wireless telephones, or any other device that can be configured for use as a game console in accordance with one or more embodiments of the present general inventive concept described herein.

An “Image Capturing system” may include both a hardware component that uses Audio Visual inputs/outputs (i.e. RCA, HDMI, and/or any other optical/audio method) capable of recording, storing, and updating competition data, as well as a web based software component that captures, analyzes, and profile data received from a hardware component (received wirelessly and/or via stable wired connection).

Unless otherwise noted or readily evident from the context as applied herein, the term “Competitor” refers to players participation on a multiplayer gaming network who may also be “Bettors” of a wagering system provided in accordance with the present general inventive concept. The terms “Competitor” and “Bettor” sometimes may be used interchangeably herein.

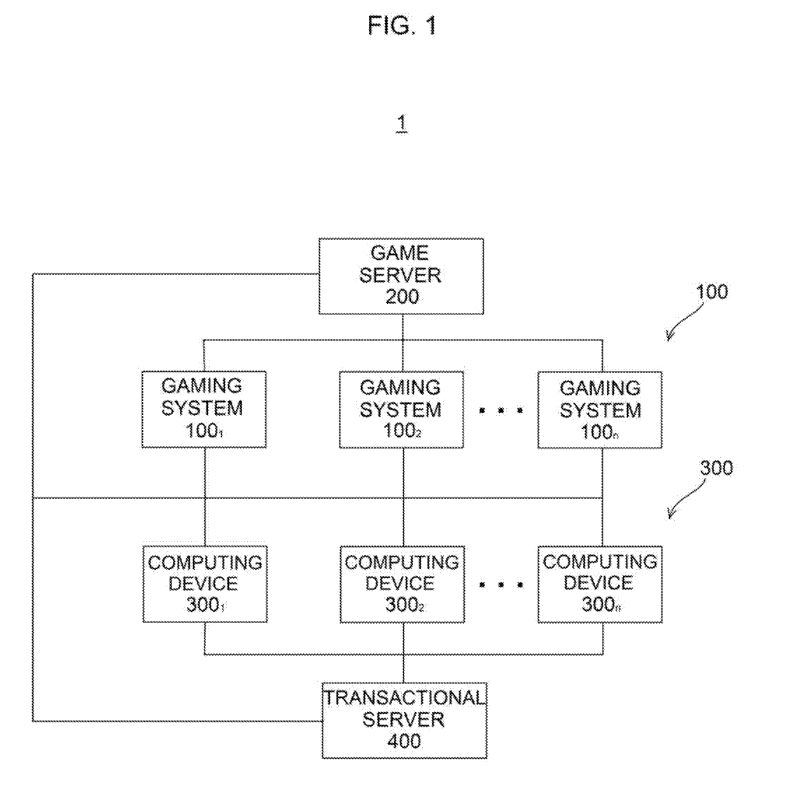

FIG. 1 is a block diagram illustrating an online game wagering system 1, according to an exemplary embodiment of the present general inventive concept.

Referring to FIG. 1, the online game wagering system 1 may include a plurality of gaming systems 100, a game server 200, a plurality of online computing devices 300, and a transactional server 400.

Each of the plurality of gaming systems 100, the game server 200, the plurality of online computing devices 300, and the transactional server 400 may communicate with each other over any stable communications network, such as, for example, the Internet.

As illustrated in FIG. 1, the plurality of gaming systems 100 may include a first gaming system 100₁, a second gaming system 100₂, . . . , and an nth gaming system 100ₙ. In other words, there is no limit as to how many gaming systems 100 are included in the online game wagering system 1.

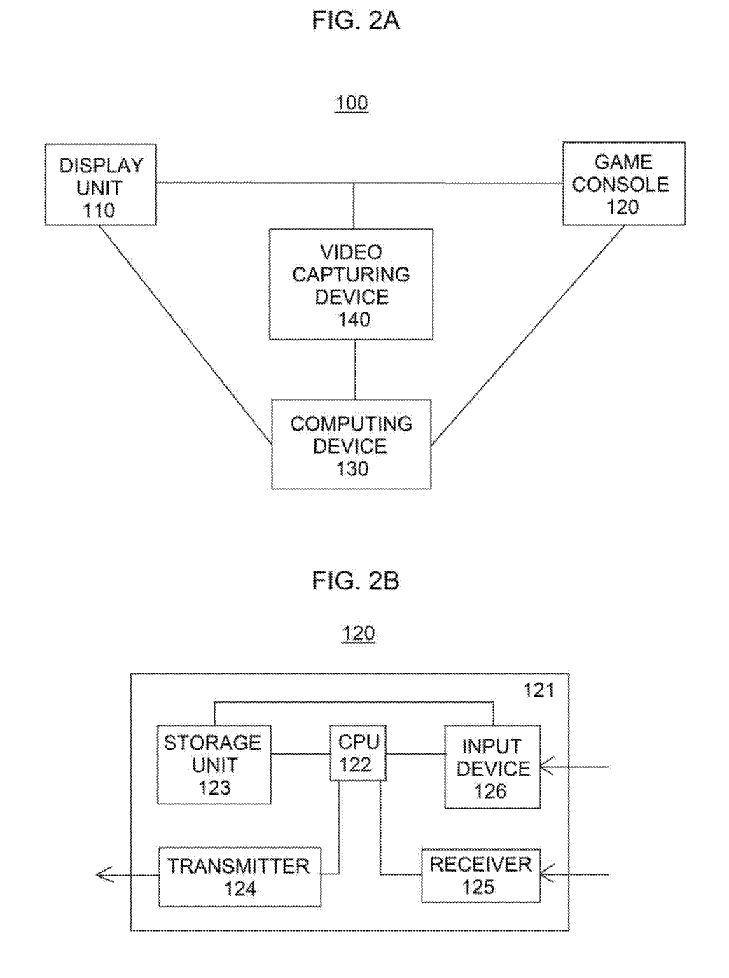

FIG. 2A is a block diagram illustrating the gaming system 100, according to an exemplary embodiment of the present general inventive concept.

Referring to FIG. 2A, each of the plurality of gaming systems 100 may include same or similar components.

For example, each of the plurality of gaming systems 100 may include a display unit 110, a game console 120, a computing device 130, and a video capturing device 140.

FIG. 2B is a block diagram illustrating the game console 120, according to an exemplary embodiment of the present general inventive concept.

Referring to FIG. 2B, the game console 120 may include a body 121, a central processing unit (CPU) 122, a storage unit 123, a transmitter 124, a receiver 125, and an input device 126.

The game console 120 may be configured to receive a video game disc or cartridge within the body 121.

The CPU 122 may include electronic circuitry to carry out instructions of a computer program by performing basic arithmetic, logical, control and input/output (I/O) operations specified by the instructions. The CPU 122 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components.

The storage unit 123 may include a random access memory (RAM), a read-only memory (ROM), a hard disk, a flash drive, a database connected to the Internet, cloud-based storage, Internet-based storage, or any other type of storage unit.

The transmitter 124 may transmit data from the game console 120 via wired or wireless technology, such as WiFi, near-field communications, BLUETOOTH, or any other type of network-based communications method.

The receiver 125 may receive data from an outside source, the data being storable in the storage unit 123, via wired or wireless technology, such as WiFi, near-field communications, BLUETOOTH, or any other type of network-based communications method.

The input device 126 may include a joystick, a game controller, a keyboard, a mouse, a trackball, a touchpad, a touch-screen, a stylus, a keypad, a proximity sensor, a microphone, or any other type of device that may receive a user input, or any combination of the aforementioned input devices 126. The input device 126 may allow a player to play a video game on the game console 120.

As such, a player may play a video game on the game console 120, which is viewable on the display unit 110, and which may be controlled by the input device 126.

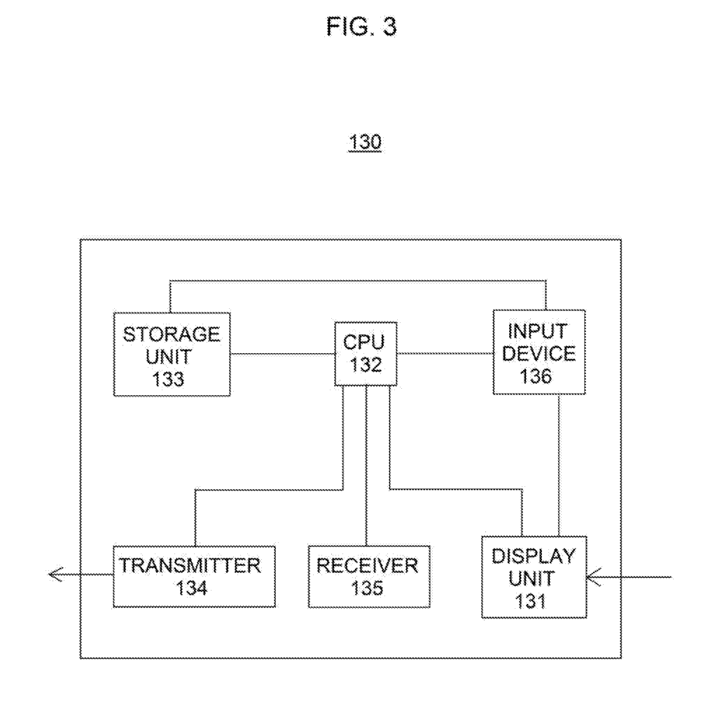

FIG. 3 is a block diagram illustrating the computing device 130, according to an exemplary embodiment of the present general inventive concept.

The computing device 130 may be any type of device that perform computations and communications, such as laptop computers, desktop computers, mobile devices, personal data assistants, tablet computers, video game systems, etc., but is not limited thereto.

The computing device 130 may include a display unit 131, a central processing unit (CPU) 132, a storage unit 133, a transmitter 134, a receiver 135, and an input device 136.

The display unit 131 may include a plasma screen, an LCD screen, a light emitting diode (LED) screen, an organic LED (OLED) screen, a computer monitor, a hologram output unit, a sound outputting unit, or any other type of device that visually or aurally displays data.

The CPU 132 may include electronic circuitry to carry out instructions of a computer program by performing basic arithmetic, logical, control and input/output (I/O) operations specified by the instructions. The CPU 132 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components.

The storage unit 133 may include a random access memory (RAM), a read-only memory (ROM), a hard disk, a flash drive, a database connected to the Internet, cloud-based storage, Internet-based storage, or any other type of storage unit.

The transmitter 134 may transmit data from the computing device 130 via wired or wireless technology, such as WiFi, near-field communications, BLUETOOTH, or any other type of network-based communications method.

The receiver 135 may receive data from an outside source, the data being storable in the storage unit 133, via wired or wireless technology, such as WiFi, near-field communications, BLUETOOTH, or any other type of network-based communications method.

The input device 136 may include a joystick, a game controller, a keyboard, a mouse, a trackball, a touchpad, a touch-screen, a stylus, a keypad, a proximity sensor, a microphone, or any other type of device that may receive a user input, or any combination of the aforementioned input devices 136.

The video capturing device 140 may be connected to the display unit 110, the game console 120, and the computing device 130.

The video capturing device 140 may be a capture card or any other type of device that is capable of capturing images from external devices via video signals, typically though HDMI, such as ELGATO, STARTECH, and RAZER RIPSHAW, but is not limited thereto. Alternatively, a user may use an application such as XSPLIT or OBS to live stream game play. As such, images from video game systems such as XBOX, NINTENDO, and PLAYSTATION may be captured to be streamed live in real time. More specifically, the video capturing device 140 may function like an input data receiver. Therefore, if a user is playing a video game on the game console 120, the video capturing device 140 may continuously receive data from the game console 120, and then transfer the received data to the computing device 130. This signal may be captured, recorded, and encoded as per need by the computing device 130, and may be uploaded or live-streamed from the computing device 130 to websites such as TWITCH.

The computing device 130 may allow a player to access a website and/or application using credentials of the player. More specifically, the player may create a player profile that includes and/or stores a password, a user name, a picture of the player, recording of games the player has played, statistics of wins/losses/ties, and other data to be stored by the website and/or application and/or server. In other words, the computing device 130 may allow the player to use the website and/or the application to register their profiles, and then subsequently to login to the website and/or the application using their respective profiles. Alternatively, the computing device 130 may have the application running thereon.

As such, the video capturing device 140 may capture live game play action images from the game console 120 that are also displayed on the display unit 110, and may send these captured images to the computing device 130. The images may them be streamed from the computing device 130 in real-time to a website, application, or server to be viewable by third party spectators and/or recorded for future viewing.

The video capturing device 140 may capture full games played by players, which may be stored on the storage unit 133 of the computing device 130, such that users may access the stored games and post the stored games as video files onto respective user profiles on social media of their preference. For example, after a player wins a game, the user may choose to post the game as a media file onto his/her own FACEBOOK page, or alternatively, onto the user's profile on the application and/or website accessible by the game server 200 or even a video-streaming webpage such as YOUTUBE.

The game server 200 may be a server located and controlled by a video game company, such as MICROSOFT, NINTENDO, and/or SONY, but is not limited thereto. More specifically, the game server 200 provides game data to the game console 120, the game data being necessary to operate particular online video games. The game server 200 may also allow various players all around the world to play each other and communicate therebetween on different game consoles 120₁, 120₂, . . . , 120ₙ.

Therefore, the game server 200 allows players to play online video games on their respective game consoles 120.

The plurality of online computing devices 300 may be any type of devices that perform computations and communications, such as laptop computers, desktop computers, mobile devices, personal data assistants, tablet computers, video game systems, etc., but are not limited thereto.

As illustrated in FIG. 1, the plurality of online computing devices 300 may include a first online computing device 300₁, a second online computing device 300₂, . . . , and an nth online computing device 300ₙ. In other words, there is no limit as to how many online computing devices 300 are included in the online game wagering system 1.

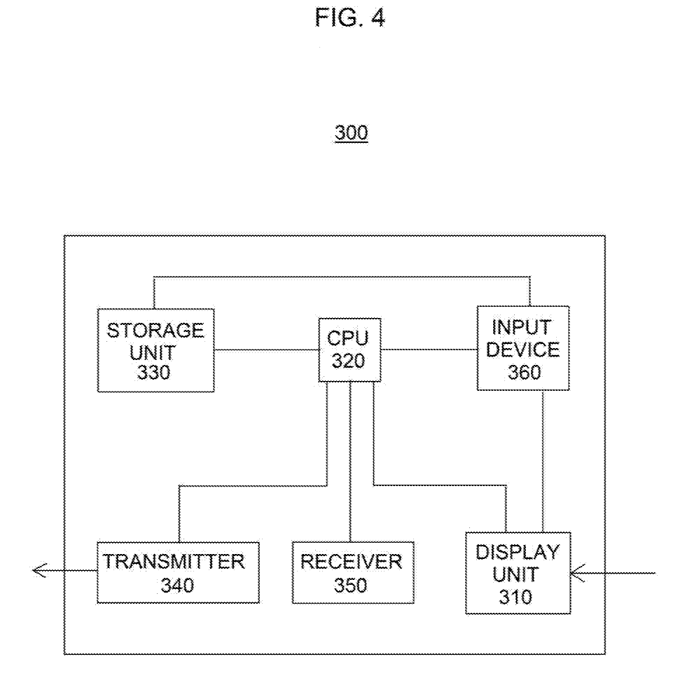

FIG. 4 is a block diagram illustrating the computing device 300, according to an exemplary embodiment of the present general inventive concept.

Referring to FIG. 4, each of the plurality of online computing device 300 may include same or similar components.

For example, each of the plurality of online computing devices 300 may include a display unit 310, a central processing unit (CPU) 320, a storage unit 330, a transmitter 340, a receiver 350, and an input device 360.

The display unit 310 may include a plasma screen, an LCD screen, a light emitting diode (LED) screen, an organic LED (OLED) screen, a computer monitor, a hologram output unit, a sound outputting unit, or any other type of device that visually or aurally displays data.

The CPU 320 may include electronic circuitry to carry out instructions of a computer program by performing basic arithmetic, logical, control and input/output (I/O) operations specified by the instructions. The CPU 320 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components.

The storage unit 330 may include a random access memory (RAM), a read-only memory (ROM), a hard disk, a flash drive, a database connected to the Internet, cloud-based storage, Internet-based storage, or any other type of storage unit.

The transmitter 340 may transmit data from the online computing device 300 via wired or wireless technology, such as WiFi, near-field communications, BLUETOOTH, or any other type of network-based communications method.

The receiver 350 may receive data from an outside source, the data being storable in the storage unit 330, via wired or wireless technology, such as WiFi, near-field communications, BLUETOOTH, or any other type of network-based communications method.

The input device 360 may include a joystick, a game controller, a keyboard, a mouse, a trackball, a touchpad, a touch-screen, a stylus, a keypad, a proximity sensor, a microphone, or any other type of device that may receive a user input, or any combination of the aforementioned input devices 360.

As such, third party spectators/bettors that are not interested in actually playing video games, may use the online computing devices 300 to watch other players who are actually playing video games in real time, on live-stream-supported websites.

Also, the online computing devices 300 may be used by the third party spectators/bettors to sign up for a website that may access the transactional server. The online computing devices 300 can also be used to create bettor profiles through the website, including personal account information, favorite games, pre-stored bet/wager amounts, favorite players, favorite tournaments, etc., which may be stored on the transactional server 400.

For example, the transactional server 400 may maintain account information for each bettor, including financial information, and may act as a trusted party to hold funds in escrow and/or secure funds to enforce terms of a wager (i.e., ensures winning players receive the winnings).

Bettors may register and fund their accounts either directly with the transactional server 400 (for example, accessing the server via a web browser). The bettors may fund their accounts through several means, such as, for example: CRYPTO-CURRENCY, BITCOIN, PAYPAL, credit cards, Automated Clearing House (ACH) transfer, cash, loyalty cards, pre-paid cards, coupons, system credit, credit earned by watching advertisements, GOOGLE CHECKOUT, etc., but funding methods are not limited thereto.

The transactional server 400 may be accessed via the plurality of online computer systems 300 through a website through a web browser and/or an application. The transactional server 400 may maintain and store data thereon regarding financial information of bettors and/or spectators, game schedules, player statistics (e.g., wins, losses, etc.), player profiles, advertisements, bettor statistics, game tournament information, account information, information regarding bets, information regarding odds, information regarding different types of bets available (i.e., trifecta, peer-to-peer, etc.), information regarding numbers of bets that have been set per game/tournament, bet maximums/minimums, etc., but is not limited thereto. The website and/or application may be accessed via the plurality of online computer systems 300, and may display and update the aforementioned data, as well as provide alerts to bettors regarding tournaments.

The website may display a schedule of games and/or tournaments that are going to be played, as well as which players are participating.

Since the transactional server 400 is communicably connected to the game server 200, players may use the transactional server 400 to schedule games and/or create tournaments. Players may also invite other players to play in the games and/or tournaments, and may also invite bettors with profiles to view the games. Players may be motivated to increase their views and/or bets by receiving incentives from the transactional server, such as coupons, money, and/or other incentives.

Players may choose to log into the transactional server 400 through the website in order to solidify that the players are going to be seriously playing a particular game until it is finished.

The website may allow bettors to perform a search for particular games and/or favorite players. As such, a particular game may be displayed with a series of dates and times associated with that particular game, along with which players are scheduled to be playing that particular game at the particular date/time. Alternatively, the bettor may search for a favorite player, whose user name and profile may be displayed, along with dates and times that the favorite player will be playing online video games.

The website may provide alerts to the online computer systems 300, based on preset data, such as bettors' favorite games, favorite tournaments, and favorite players. Therefore, for example, when a CALL OF DUTY tournament is scheduled to start, a bettor may receive an alert on his mobile device regarding the details of the scheduled tournament. Likewise, if a bettor has a favorite player set up for alerts, then every time the favorite player schedules game play, the bettor receives a notification stating that the favorite player will be playing on a particular day and at a particular time. Alternatively, if a game has not been pre-scheduled, the bettor may receive a notification that a favorite player is in the process of starting a new game.

Prior to game play, transactional server 400 may receive credential information from each player and/or bettor, and then may authenticate the credentials. Authentication by the transactional server 400 may include age and location controls to ensure local law compliance. Age can be entered by the bettor, and the bettor's location can be verified by any of a billing address used to fund an account, a GPS location of a mobile device (if available), and an IP address of the bettor's online computer system 300.

When a bettor places a bet on a game or tournament, the transactional server 400 may secure the bettor's funds. Secured funds cannot be withdrawn or used for another wager until the game or tournament is over. Securing the funds can include transferring the funds from the bettor's account to an escrow account as well as placing a “hold” on the funds in the bettor's account.

The transactional server 400 may also provide timer countdown to prepare bettors that no more bets will be accepted within a predetermined amount of time.

Once the transactional server 400 secures funds from all participating spectators, a tournament or game may proceed. The tournament/game may proceed under normal game mechanics as provided by the game server 200, until game play completes. The transactional server 400 may receive and store completed game statistics from the game server 200, or, alternatively, directly from each of the plurality of gaming systems 100.

The game statistics may indicate winners and losers based on one or more in-game metrics. A player may also determine one or more custom in-game metrics to be used in determining winners and losers during tournament/game initialization. The transactional server 400 may transfer funds to winners of bets, and may notify all bettors of the wins, losses, and fund transfers. Additionally, the transactional server 400 can send the game statistics to each of the plurality of gaming systems 100, which provides the game statistics to the players.

Furthermore, the transactional servicer 400, or the website/application may send notifications to bettors and/or players regarding game times and/or dates, tournaments, or other information regarding online games.

Game statistics sent to the transactional server 400 from either the game server 200 or from each of the plurality of gaming systems 100 can include summary level statistics such as winners and losers and/or specific in game actions such as player orientation within the gaming environment, player actions (e.g. buttons pressed or character movement), or user display details. The user display details can include, but are not limited to, graphics card-information, in-game screen shots and live action game-play. These statistics can be used to determine system level player-rewards that are independent from tournament outcomes as well as in the detection of fraudulent behavior through any of the following: real-time tournament monitoring, delayed tournament review, or statistical player review for idiosyncratic behavior or behavior characteristic of fraudulent play.

Other methods of limiting/preventing fraudulent play may be included. For example, since previously-played games may be stored on the transactional server 400, bettors may watch previously-played games of particular players in order to become familiar with the particular players' game play tendencies and strategies. As such, the bettors may make more sapient decisions regarding placing bets.

The website/application may allow bettors and/or players to send emails to each other, and may also have functionality to provide real-time messaging.

Various types of bets may be placed by bettors, based on types of games and/or tournaments that are scheduled for play.

For example, if a one-on-one CHESS game is scheduled for play between two players (e.g., Player 1 and Player 2), a bettor may choose to place a bet on Player 1 for $10.00, for example. The bettor may then wait to see if other bettors come to place bets on Player 2, or may alternatively send notifications to other bettors via the website/application and/or the transactional server 400.

If four other bettors each bet $10.00 on Player 2, then the bets seem to be uneven. As such, prior to the CHESS game commencing, a notification may be sent to all bettors that all bets are about to be locked. The notification may also include a warning sent to all bettors that the bets are uneven, because Player 1 only has one bettor betting $10.00, while Player 2 has four bettors betting $10.00 (totaling $40.00 altogether bet on Player 2). The notification may allow the bettors to choose from various options. Once bets are locked by the system, they cannot be changed.

Option one would be to maintain all bets. Therefore, if all bettors choose to keep their bets in play, and if Player 1 wins, the bettor who bet on Player 1 would receive $2.50 from each bettor who bet on Player 2. Alternatively, if all bettors choose to keep their bets in play, and if Player 2 wins, the four bettors who bet on Player 2 would each receive $2.50 from the bettor who bet on Player 1. In other words, uneven bets would be distributed evenly. As such, a bettor can never lose more than he/she bet.

Option two would be to drop out of the bet. For example, if there is one bettor betting $10.00 on Player 1, and twenty bettors each betting $10.00 on Player 2, then some of the bettors betting on Player 2 may choose to drop out of the bet because the distribution of money would only be $0.50 per bettor if Player 2 wins. However, the risk for the bettors betting on Player 2 would also be lessened in this scenario, because they would only be each liable for $0.50 if Player 1 wins.

Option three would be to increase or decrease bets. For example, if one bettor bets $10.00 on Player 1, and four bettors each bet $10.00 on Player 2, the bettor betting on Player 1 may choose to increase the bet to $40.00 (or less). As such, if Player 1 wins, the bettor betting on Player 1 would receive $10.00 from each bettor who bet on Player 2. Alternatively, if Player 2 wins, then the $40.00 would be distributed evenly to each of the bettors who bet on Player 2 (i.e., $10.00 to each bettor who bet on Player 2).

This increasing/decreasing of bets may be facilitated through the messaging capabilities of the system, so that bettors may communicate with each other instead of “blindly” increasing/decreasing bets.

Also, bet minimums and maximums may be associated with different games and/or bettor accounts, in order to prevent bettors from over-betting or under-betting.

If a tournament-style game is scheduled, then betting may be similarly performed as above in the one-on-one game, but with slight differences. For example, if twenty players sign up for a CALL OF DUTY tournament, there may be a predetermined bet amount required, such as $50.00, that is all accumulated in a “community pot.” Therefore, whoever bets on the winner of the tournament receives the entire amount accumulated in the community pot.

Also, there may be different percentages of winnings distributed to bettors who bet on 1^{st} place, 2^{nd} place, and 3^{rd} place finishers. For example, bettors who bet on a 1^{st} place finisher may receive 60% of the total community pot, while bettors who bet on a 2^{nd} or 3¹ place finisher may receive 30% and 10%, respectively, of the total community pot.

Furthermore, there may be limits on how many bettors may bet on a particular player. For instance, there may be a limit of two bettors per player, in order to prevent too many bettors betting on one particular player.

Other more complicated functionalities may be applied to the online game wagering system 1, such as assigning “odds” to various players based on their wins/losses records (i.e., making particular players “underdogs,” based on their opponents), parlays, over/unders, etc.

Although placing bets on the online game wagering system 1 may be free, winners of bets may be liable of a percentage of their winnings to administrators or owners of the online game wagering system 1 (i.e., this is similar to “the house” receiving a predetermined percentage of winnings for supplying a place to play and make bets). For example, if a bettor wins $10.00, ten-percent ($1.00) may be automatically extracted as a service fee, and sent to an administrator account.

As such, the online game wagering system 1 may fund itself and prevent any sign-up fees and/or maintenance fees. However, sign-up fees for various accounts, such as premium accounts that allow for larger bets, may be required.

Additionally, the online game wagering system 1 and the website/application may include a registration feature for organizations that want to become partners/affiliates with particular games, systems, or even individual players. For example, companies such as casinos, TWITCH, YOUTUBE, STEAM, etc., may send requests to games, systems, or individual players, to become affiliated therewith, such that funds can be sent back-and forth therebetween, and advertisements may be posted automatically on the games, systems, or individual players sites and/or profiles.

Additionally, the online game wagering system 1 and the website/application may include a tax calculation feature, which automatically calculates and/or pays taxes for users who have won funds.

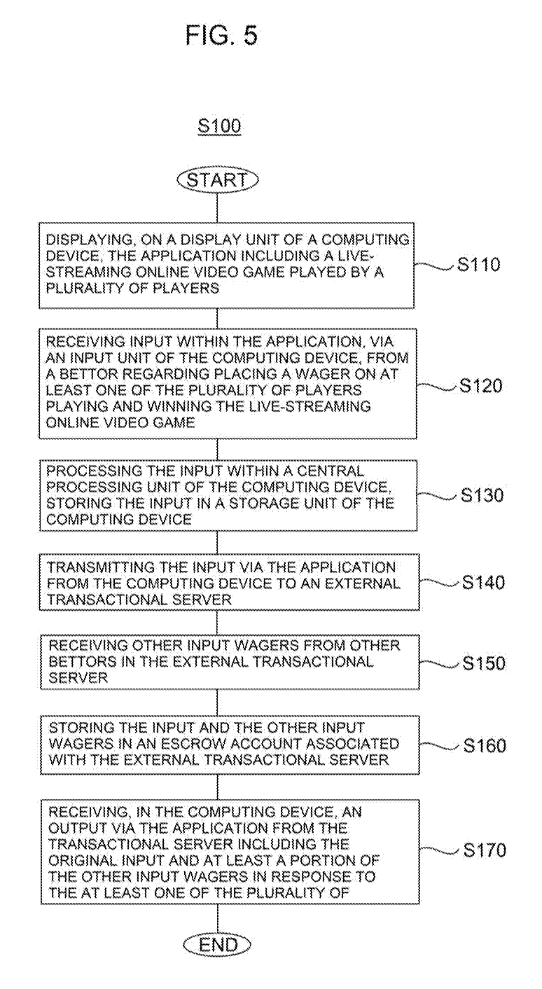

FIG. 5 is a flow chart illustrating a method of wagering on online games of skill, according to an exemplary embodiment of the present general inventive concept.

Referring to FIG. 5, the method S100 of wagering on online games of skill may include displaying, on a display unit of a computing device, the application including a live-streaming online video game played by a plurality of players (S110), receiving input within the application, via an input unit of the computing device, from a bettor regarding placing a wager on at least one of the plurality of players playing and winning the live-streaming online video game, processing the input within a central processing unit of the computing device (S120), storing the input in a storage unit of the computing device (S130), transmitting the input via the application from the computing device to an external transactional server (S140), receiving other input wagers from other bettors in the external transactional server (S150), storing the input and the other input wagers in an escrow account associated with the external transactional server (S160), and receiving, in the computing device, an output via the application from the transactional server including the original input and at least a portion of the other input wagers in response to the at least one of the plurality of players winning the live-streaming online video game (S170).

As stated above, players (i.e., competitors) have an ability to challenge each other via formal request within the system network. These formal requests may be referred to as a “challenge option.” The “challenge option” may present potential competitors with a digital notification disclosing an open challenge to and from another registered competitor, amount to be wagered, and game to be wagered on. Competitions are won or lost based on desired “form of competition” (or parameters required to win). Different forms of competition include but are not limited to: acquiring the most points, acquiring the most kills, completing competition with a best time, acquiring the most assists, completing challenges with the least deaths, completing game objective first, completing challenges with the best statistical Ratio, accumulating the largest combo, and winning or losing a competition/contest.

If the challenged competitor accepts the challenge, the challenge option may prompt the competitors to schedule a date and time for the competition. Once the challenge option is accepted, an invitation may be sent to registered bettors within system network via an update center, as well as to users (i.e., bettors/spectators) who have subscribed to “follow” either or both competitors. The invitation may also display calculated competitor statistics, wagering odds (calculated based on competitor statistics), and time of the competition. Bettors may then be presented with options to wager on the competition and/or stream the event on its date via any web accessible device (i.e. cellphone phone, iPad, computer, smart TV, or any present or future web-based device capable of streaming). Forms of competition may include, but are not limited to the following types of competitions:

One VS. One Competition—One competitor competes against another competitor in a digital contest or competition. Each competitor may wager an amount against another competitor. Also, third-party non-playing bettors may wager on one competitor to win against another competitor. Odds of the wager may be determined by data calculated based on captured images by image capture system.

One VS. Multiple—One competitor competes against a plurality of competitors (i.e., multiple competitors) in a digital contest or competition. Here, bettors may wager on either the one competitor, or the plurality of competitors. The odds of wagering are determined by data calculated based on captured images by image capture software, however the prize for wagering on the single competitor may be multiplied by the number of competitors. Bettors wagering on the plurality of competitors (if the plurality of competitors win) receive prize based on the odds divided by the number of winning competitors.

Multiple VS. Multiple—Multiple competitors compete against multiple competitors in a digital competitions and or contest. Each team of competitors' wagers are combined, and the winning team receives combined payout divided by the number of Competitors on the winning team. Bettors' wagers on winning teams are paid in the same capacity as “ONE vs ONE” competitions.

Free For All—Competitors compete against multitude of Competitors, in a non-cooperative competition/contest. Each of the competitors may wager on themselves against competitors doing the same. Bettors can wager on any competitor to win (including multiple bets on multiple competitors).

The present general inventive concept differs from U.S. Patent Publication Number 2013/0178259 (herein referred to as “259”), which is directed to a system that autonomously creates virtual events within a virtual world. The present general inventive concept, however, does not create virtual events, but instead finds registered users on multiplayer gaming networks (i.e., XBOX MICROSOFT gaming network, SONY PLAYSTATION network, etc.), and captures live images to determine winning/losing wages and paying out to winning bettors and competitors.

The present general inventive concept also differs from WIPO Publication Number 2009/027158 (herein referred to as “158”), which teaches bettors wagering on mini events (computer-generated) during real world sporting events. The present general inventive concept, however, is directed to wagering on digital video game competitions/contests on a multiplayer game network.

The present general inventive concept also differs from U.S. Patent Publication Number 2005/0148388 (herein referred to as “388”), which teaches rendering interactive virtual environments), allowing users to compete within virtual environment. The present general inventive concept, however, does not create a virtual environment for users to compete in, and instead, captures images from digital competitions taking place on an independent multiplayer gaming network.

U.S. Patent Publication Number 2005/0044575 (herein referred to as “575”) also differs from the present general inventive concept, for at least the reason that it teaches an interactive simulation on an entertainment server. In contrast, the present general inventive concept does not create the images nor competition(s)/Contest(s) to be played and/or wagered on, but instead locates players that have agreed to scheduled competition via computer based wagering system to take place on independent multiplayer gaming network.

U.S. Patent Publication Number 2007/0004509 (herein referred to as “509”) teaches users of wagering system first communications with host system to verify “winner/loser” of wagers, whereas the present general inventive concept is directed to verification of “winning/losing” via a non-circulatory image capturing program within host wagering system. “509” teaches at least one of the web site pages is configure to allow the players to select from among a set of video games that can be played for wagers. However, the present general inventive concept is directed to players deciding terms of competition (including wager amount, platform of competition/contest) and, for non-competing bettors, a feed of upcoming matches to wager on. “509” further includes connectivity software operatively associated with at least one game console of at least one of the players, the connectivity software being configured to communicate with the server. The present general inventive concept, however, is directed to a wagering system that allows players to compete on any device connectable to any multiplayer online gaming network without the use of any third party software downloaded to player gaming device(s) by capturing images from the competition(s)/contest(s) and determining winner/loser and paying out associated wages.

U.S. Patent Publication Number 2002/0037767 (herein referred to as “767”) teaches a competency structure operatively associated with the server, the competency structure being configured for maintaining at least one skill level of at least one of the players, and further determining compatibility including comparing skill levels associated with the players. The present general inventive concept, however, does not rate players by skill level, rather gathers images from competitor(s) previous competitions and calculates odds of winning (for bettors) against another competitor(s). The present general inventive concept does not match players at all, but instead allows players to freely challenge each other despite skill level.

U.S. Patent Publication Number 2007/0087804 (herein referred to as “804”) teaches multiple wagering opportunities on a single event. The present general inventive concept inversely teaches only one wagering opportunity per player per game. “804” continues to teach the wireless gaming device wherein the award of a random bonus is sent to the wireless device via the wireless interface from a bonus server. The present general inventive concept differs from “804” in that bettors bet on specific competitors to win within a digital competition/contest, while competitors bet on themselves to win and neither bettors nor competitors receive bonuses before/during/after any wager.

The present general inventive concept greatly differs from U.S. Patent Publication Number 1996/0027864 (herein referred to as “864”), which teaches Image capturing of predetermined lengths and/number of images required before image capture. “864” also teaches stored video images recorded during monitoring in a fixed number of files such that once the maximum number of files to be stored during monitoring has been reached, the oldest file is deleted and the newly captured video images file is stored in a new location in storage. Thus, storage of the files during monitoring has the appearance of a circular format. The present general inventive concept, however, is directed to image capturing triggered by competitors with no predetermined length of capture time nor maximum number or captured images.

Lastly the present general inventive concept differs from WO number 2007/0077994 (herein referred to as “994”), which teaches installing third-party software to a video game console to enable video game wagering. The present general inventive concept, however, is directed to a computer-based system that allows video game wagering on multiplayer game networks by capturing images from said networks, eliminating the need for any third-party software.

In certain exemplary embodiments, the present general inventive concept may be able to access images from independent multiplayer gaming network(s) (e.g., MICROSOFT XBOX network, SONY PLAYSTATION network, WII-U NINTENDO network, etc.). More specifically, an Image Capturing System, according to exemplary embodiments of the present general inventive concept, here referred to as “capture device,” may search for competitions (scheduled via a challenge option) by scanning Image Capture Hardware system component(s) for competitors via screen name and other information entered in competitor profiles. The capture device, having located both (scheduled) competitors, may begin to record the competition images including videos, saving them to a web based server. Images from this competition may be simultaneously streamed throughout system network to non-registered users for non-wagered viewing, and bettors (after having made a wager and opted in for live feed). Once competition is concluded, the capture device may determine winner and loser parties, and may update competitor profiles or statistics, saving the images and statistical data to competitors' profiles' within system network.

In other exemplary embodiments, an image capture system may be configured to operate on-board transportation vehicles not limited to trains, cars, buses, or planes. In these exemplary embodiments, the image capture system may be configured for competitors to sign into their profiles in order to compete in wagered competitions and contests. The image capture system may still transmit images to the system network. Bettors and non-registered users may manage their wagers via mobile application or through web-based network.

In other exemplary embodiments image capture system may be configured to operate in an arcade setting. An “arcade setting” is defined as any live setting in which multiple competitors and bettors may gather to compete and wager with and against each other. In this exemplary embodiment, multiple image capture devices may be configured to interact with the web based system.

The present general inventive concept, alternatively, may be referred to as “system” or “system network,” and may capture, document, stream, and calculate odds based on images of live and prior wagered digital competitions within a multiplayer gaming networks allowing players to wager against each other while simultaneously allowing bettors to wager on the outcome of competition(s), based on statistical data compiled by a calculation program within the system. Notifications about digital competitions, past, present, and future, and any wager relating to the competition may be made available to bettors, via SMS, mms, email, instant message, or other digital notification, along with live video feed and/or recorded video feed of competitions. Captured images may be stored on network database within the system, and players logged into system may create profiles that containing statistical data based on captured images from the multiplayer game network.

Although various exemplary embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An online game wagering system, comprising:
a plurality of gaming systems to allow a plurality of users to play an online video game thereon;
a game server to provide, to the plurality of gaming systems, data required to access, operate and play the online video game on the plurality of gaming systems;
a plurality of online computing devices to allow a plurality of third party spectators to view the online video game as it is played by the plurality of players in real time; and
a transactional server to communicate with the plurality of online computing devices to allow the plurality of third party spectators to place wagers on at least one of the plurality of users playing the online video game.

2. The online game wagering system of claim 1, wherein each of the plurality of gaming systems comprises:
a display unit to display images related to the online video game thereon;
a game console to allow at least one of the plurality of users to play the online video game;
a computing device to allow the at least one of the plurality of users to access at least one of a website, an application, the game server, and the transactional server, using credentials of the at least one of the plurality of users; and
a video capturing device to capture live game-play images corresponding to the online video game from the game console that are also displayed on the display unit, and to transmit these captured live game-play images to the computing device in real time.

3. The online game wagering system of claim 2, wherein the captured live game-play images corresponding to the online video game are streamed from the computing device in real-time to the at least one of the website, the application, the game server, and the transactional server, to be viewable by the plurality of third party spectators.

4. The online game wagering system of claim 2, wherein the captured live game-play images are stored on the at least one of the website, the application, the game server, and the transactional server.

5. The online game wagering system of claim 4, wherein the computing device allows each of the plurality of players to access the stored captured live game-play images and to transmit the stored captured live game-play images to at least one of a profile stored on the at least one of the website, the application, the game server, and the transactional server, a social media webpage corresponding to at least one of the plurality of players, and a video-streaming webpage.

6. The online game wagering system of claim 2, wherein the computing device allows the at least one of the plurality of users to access the at least one of the website, the application, the game server, and the transactional server, to register a profile and to log into the at least one of the website, the application, the game server, and the transactional server, using the profile.

7. The online game wagering system of claim 2, wherein at least one of the plurality of users may invite another one of the plurality of users via the computing device.

8. The online game wagering system of claim 1, wherein at least one of the website, the application, and the transactional servicer sends notifications to at least one of the plurality of users and the plurality of third party spectators regarding at least one of online video game times, online video game dates, and online video game tournament times, online video game tournament dates, information regarding at least one of the plurality of users, and information regarding the online video game.

9. The online game wagering system of claim 1, wherein the online video game is a skill-based video game.

10. The online game wagering system of claim 1, wherein the plurality of gaming systems are disposed in different locations around the world.

11. The online game wagering system of claim 1, wherein the transactional server receives and authenticates credential information received from at least one of the plurality of players and the plurality of third party spectators.

12. The online game wagering system of claim 11, wherein the authentication by the transactional server includes age and location authentication of the at least one of the plurality of players and the plurality of third party spectators to ensure local law compliance.

13. The online game wagering system of claim 1, wherein the transactional server receives electronic transfers of funds from the plurality of third party spectators via the plurality of online computing devices, and secures the funds in an escrow account such that the funds and additional funds are retrievable by at least one of the plurality of third party spectators via at least one of the plurality of online computing devices after the online video game play has finished.

14. The online game wagering system of claim 1, wherein the transactional server receives and stores completed game statistics related to the online video game from at least one of the game server and the plurality of gaming systems.

15. A computing device running an application thereon, the computing device comprising:
a display unit to display the application including a live-streaming online video game played by a plurality of players;
an input device to receive input within the application from a bettor regarding placing a wager on at least one of the plurality of players playing and winning the live-streaming online video game;
a central processing unit (CPU) to process the input;
a storage unit to store the input;
a transmitter to transmit the input via the application to an external transactional server that also receives other input wagers from other bettors and stores the input and the other input wagers in an escrow account; and
a receiver to receive an output via the application from the transactional server including the original input and at least a portion of the other input wagers in response to the at least one of the plurality of players winning the live-streaming online video game.

16. The computing device of claim 15, wherein the live-streaming online video game is a game of skill.

17. A method of wagering on online games of skill, the method comprising:
displaying, on a display unit of a computing device, the application including a live-streaming online video game played by a plurality of players;
receiving input within the application, via an input unit of the computing device, from a bettor regarding placing a wager on at least one of the plurality of players playing and winning the live-streaming online video game;
processing the input within a central processing unit of the computing device;
storing the input in a storage unit of the computing device;
transmitting the input via the application from the computing device to an external transactional server;
receiving other input wagers from other bettors in the external transactional server;
storing the input and the other input wagers in an escrow account associated with the external transactional server; and
receiving, in the computing device, an output via the application from the transactional server including the original input and at least a portion of the other input wagers in response to the at least one of the plurality of players winning the live-streaming online video game.
